(19) United States
(12) Patent Application Publication
(10) Pub. No.: US 2002/0083362 A1
(43) Pub. Date: Jun. 27, 2002

(54) System and method for providing unattended personality acquisition, self-recovery and remote maintenance to internet-based end-user devices

(75) Inventors: Stefan I. Semo, Cliffside Park, NJ (US); David E. Y. Sarna, Teaneck, NJ (US)

Correspondence Address: KLAUBER & JACKSON, 411 HACKENSACK AVENUE, HACKENSACK, NJ, 07601

(73) Assignee: OBJECTSOFT CORP.

(21) Appl. No.: 09/745,376

(22) Filed: Dec. 22, 2000

(51) Int. Cl. H04L 1/22

(52) U.S. Cl. 714/4

(57) ABSTRACT

An apparatus in communication with a central monitoring station with a stored set of preprogrammed instructions designed for the unattended use by the general public is initially installed in the field, by establishing a basic connectivity to the monitoring station to report its tag information in order to retrieve the corresponding personality information, then in the event of a failure, the image containing an operating system on a primary partition is recreated from a secondary partition as well as the redundant copy of the personality information.

### BACKGROUND INFORMATION

1. Field of Invention

The present invention relates to a system and method for updating and maintaining remote end-user devices. More particularly, the present invention relates to a system and method for remotely updating and/or repairing computer peripherals, such as Kiosk, ATM machines, and other Internet-based end-user devices.

2. Description of the Related Art

Computer systems, such as kiosks, ATM machines and Internet-based appliances which are designed for unattended use by the general public, are deployed by many companies in order to advertise and promote their products and services. The main objective of these devices is to sell products and provide product-related information and the like.

With the advent of significant developments in connection with Internet technologies, remote computer systems are being deployed rampantly in order to create multi-media channels to advertise, sell, and maintain various products and service related information. Accordingly, a person wishing to obtain information about any particular product or service has a number of available search options.

The dissemination of consumer-product/service information must be accurate, dynamic, and custom-tailored in a particular geographical region. Certain types of products/services require regular or periodic updating. Hence, the computer systems used to provide the necessary information need to be installed efficiently, updated promptly, and repaired periodically.

Typically, once the remote system becomes unavailable or non-functional, the system is not operable until the trouble is noticed, reported, and a technician is dispatched to repair the system. Even if a maintenance person were sent to the site where the system exists, most maintenance crews have difficulty in reviving the system due to complex operation involved in the maintenance and repair processes.

In most instances, the problem associated with the systems is caused not by a hardware failure but by unforeseeable circumstances that were not anticipated by the designer or software testing engineers. Such conditions are known in the industry as “latent software bugs”. Under certain circumstances these latent software bugs cause system failures as the stored program or its related data, or a part thereof, is destroyed or inaccessible. In this event, a service call is required to reload the necessary software to revive the system. Meanwhile, the system will be out of commission and inaccessible for several days until the service call is completed.

Moreover, addressing the above problem is further complicated by the fact that the stored programs and data are usually updated from time to time, making it more difficult to reload or duplicate the exact image of the software and data at the time of failure. Normally, a back-up image is typically made on a daily basis or at a predetermined time interval, then the backup is used to restore in the event of failure. However, the practicality of preparing a full backup each evening is not feasible with the remote systems as the volume of programs and data to be backed up are too great to be transferred via the limited communications channel capacity. This is because a communication channel is mainly used for mere monitoring and/or updating purposes.

As described above, even with a fast digital connection available today, it is very difficult to upload a hard drive (HD) full of data to a remote device. Accordingly, an enormous amount of time, money, and effort are being wasted by companies to maintain, update, and repair a remote computer system when the system is not operational. A maintenance technician must be dispatched at a great expense to the location where the computer system exists. Accordingly, there is a need for a system and method for repairing, updating, and maintaining remote Internet-based end-user systems efficiently and economically.

The foregoing and other objects, features, and advantages of the invention will be apparent from the following, more detailed description of preferred embodiments as illustrated in the accompanying drawings in which reference characters refer to the same parts throughout the various views. The drawings are not necessarily to scale, the emphasis instead placed upon illustrating the principles of the invention.

### SUMMARY OF THE INVENTION

It is, therefore, an objective of the invention to provide a system and method for automatically updating, repairing, and maintaining remote end-user systems, as needed.

It is an object of this invention is to provide a redundant copy of the software and related data in a compressed form and to provide a mechanism for easily recreating the original data, thereby allowing the prompt restoration of the proper function for remote end-user systems.

Another object of the present invention is to provide a novel system and method for efficiently installing computer-based end-user devices efficiently by simply entering identifiable tag information associated with each end-user device.

Another object of this invention is to provide an improved method for reliably entering personality information into the remote system.

Another object of the present invention is to provide a novel system and method of automatically restructuring the link between computer-based end-user devices and a remote monitoring system efficiently and economically.

Another object of the present invention is to provide a novel method of updating a database for use within the product information finding and purchasing.

Another object of the invention is to provide a novel system and method of manually repairing computer-based end-user devices that are user friendly and efficient.

### BRIEF SUMMARY OF DRAWINGS

The invention will be better understood and its numerous objects and advantages will become more apparent to those skilled in the art by reference to the following drawings, in conjunction with the accompanying specification, in which:

FIG. 1 illustrates a graphical representation of the embodiment of the computer-based system of the present invention;

FIG. 2 illustrates a graphic representation of a repair activation protocol according to the present invention;

FIG. 3 is a flow chart illustrating the steps involved in assembling the computer-based system of the present invention;

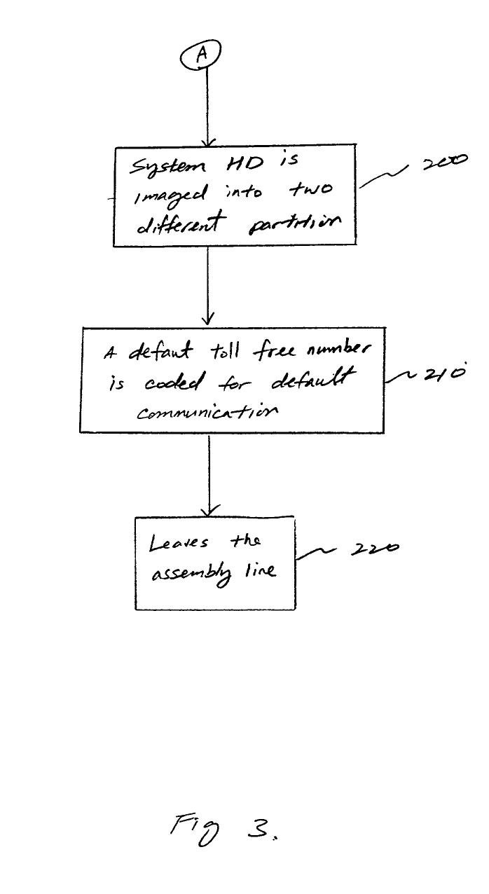

FIG. 4 is a flow chart illustrating the steps involved in registering and activating a computer-based system of the present invention;

FIG. 5 is a flow chart illustrating the steps involved in performing an unattended remote recovery process for a computer-based system of the present invention; and,

FIG. 6 is a flow chart illustrating the steps involved in a 1manual recovery process for a computer-based system of the present invention.

### DETAILED DESCRIPTION OF THE PREFERRED EMBODIMENTS

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments which depart from these specific details. For the purpose of clarity, detailed descriptions of well-known devices, circuits, and methods are omitted so as not to obscure the description of the present invention with unnecessary detail.

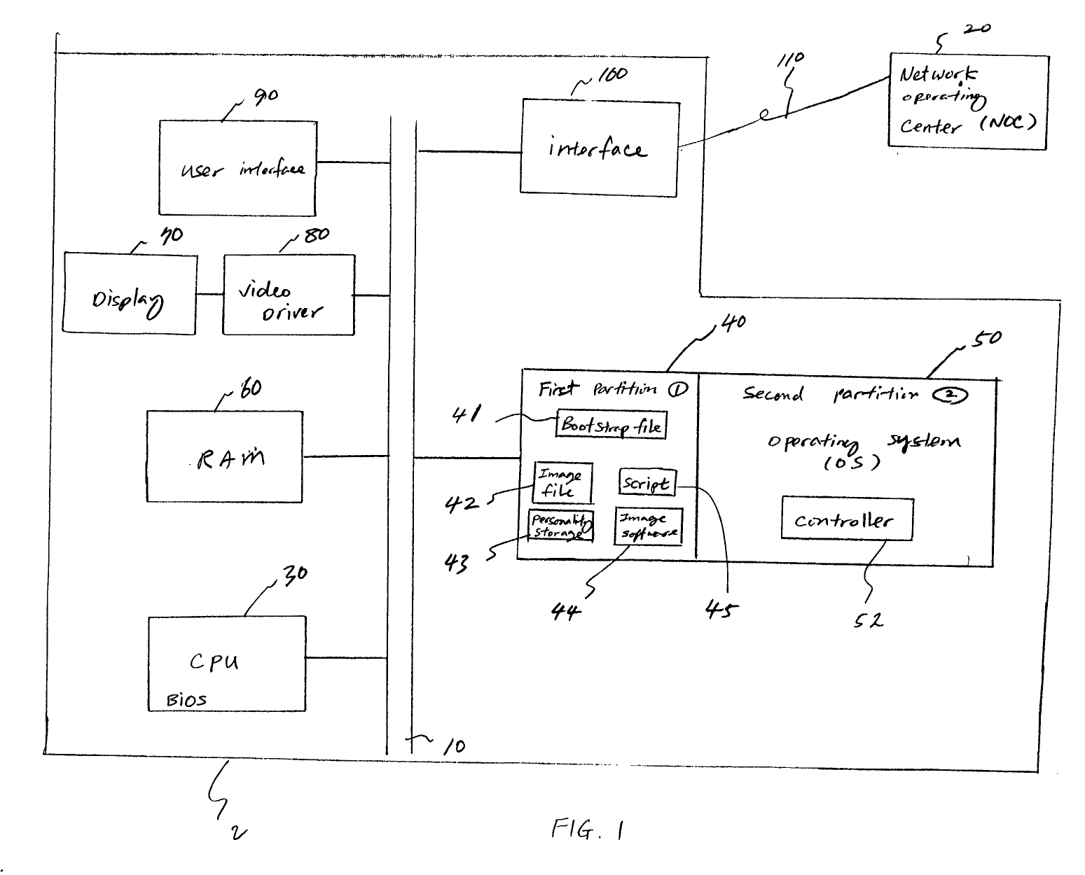

Referring to FIG. 1, the major components of a computer-based remote end-user system 2 according to the present invention includes a CPU(central processing unit) 30, a local system hard drive having a first partition 40 and a second partition 50, a RAM 60, a display unit 70, a video driver 80, an user interface, and an interface unit 100. The hardware and software of the present invention relate to general personal computers configured with a software having a BIO (Basic Input Output System) layer, software application layers, and data layers. Preferably, the invention relates to a personal computer-type system operating under the CPU 30 of the type manufactured by Intel, Inc. of Sunnyvale, Calif., or Advanced Micro Devices (AMD) of Sunnyvale, Calif., and a GU (Graphical User Interface) operating system of the type manufactured by Microsoft, Inc. of Redmond, Wash. Also, the remote system 2 according to the present invention uses a suitable computer system having a Pentium(R) or a higher CPU running Microsoft Windows NT system or a higher Operating System from a software from Microsoft Corporation.

The first partition 40 stores a file that can rewrite a boot process program (hereinafter referred to as BOOTSTRAP file), an image file 42, a personality storage 43, an image software 44, and a script 45. In the embodiment of the present invention, an operating system (OS) is imaged onto the second partition 50 from a bootable CD-ROM, then a compressed image of the second partition 50 is stored in the image file 42 of the first partition 40. The personality storage 43 stores personality information. In general, the personality information refers to the necessary data that describe the remote end-user devices and other connectivity-related information, which enable the devices to communicate with and be monitored by the network operating center (NOC). The personality also includes marketing displayable data covering various products and services that are location dependent. This geographic dependent data is frequently updated and thus cannot be preprogrammed in a factory. The image software 44 is selected from commercially available imaging software, i.e., Symnantec's Norton Ghost. The script 45 is used for activating the image software 44 to perform an imaging operation, namely, copying the compressed image stored in the image file 42 to the second partition 50.

Normally, it is standard industry practice that all program files, i.e., an operating system (OS), shipped with the computer-based devices are customarily stored into a primary partition in a non-volatile storage medium such as a magnetic disk drive. This is sometimes referred as a “disk image.” Hence, all similar computer devices have identical copies of the same disk image. However, the remote system 2 according to the present invention includes a partitioned hard drive: one partition containing the operating system and the other paritition will contain an image of the operating system. To this end, the multitasking operating system (OS) and a controller 52 are stored in the secondary partition 50, as shown in FIG. 1. Also, a compressed back-up image of the disk drive of the secondary partition 50 is stored in a separate, first partition 40 during the manufacturing stage. This redundant image is referred as “flash image”. The installation of this disk into a remote system 2 allows the CPU 30 to operate the multitasking OS stored in the second partition 50. The first partition 40 further includes the script 45 and the imaging software 44 in the form of an executable program. The program for the script 45 and controller 52 may be written in any suitable programming language, such as Visual Basic C++, an object-oriented programming language (i.e., JAVA™ programming language), etc.

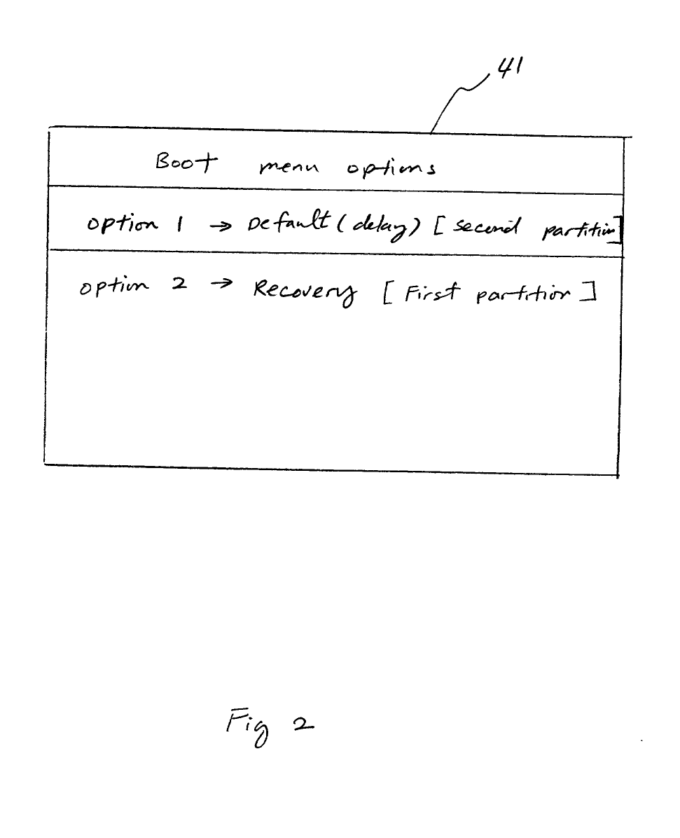

According to the present invention, in the event of a failure or as occasion demands, the image stored in the image file 42 in the first partition 40 and the personality information stored in the personality storage 43 are copied to the second partition 50 (the copying mechanism is described later). Depending on the specific situation, the recreation of the first partition 40 may be initiated automatically by the remote system 12, the NOC 20, or manually activated by a user through a simple command. As shown in FIG. 2, the BOOTSTRAP file 41 is programed to operate in two different modes. Basically, the first mode is set to boot the system from the second partition, whereas the second mode is set to boot from the first partition. A default is programmed in the first option, but it can be changed. Hence, the user can selectively reboot the remote system 2 during a manual mode. A detailed description of manually repairing the remote system 2 will be described later.

Moreover, according to the embodiment of the present invention, a default toll free number is stored for default communication, so that each remote system 2 installed in different locations can communicate with the network operating center (NOC) via the designated default number.

Furthermore, in the embodiment of the present invention, a network operating system (NOC) 20 is adaptably coupled to a telephone network to communicate with a remote system 2, i.e. a kiosk, an ATM, and other end-user stations, via a an analog or digital connection 110. Alternatively, a network interface card can be used to communicate with the NOC 20 via a Local Area Network (LAN) or a Wide Area Network (WAN) through wireless connections.

### INITIALIZATION OF THE REMOTE SYSTEM

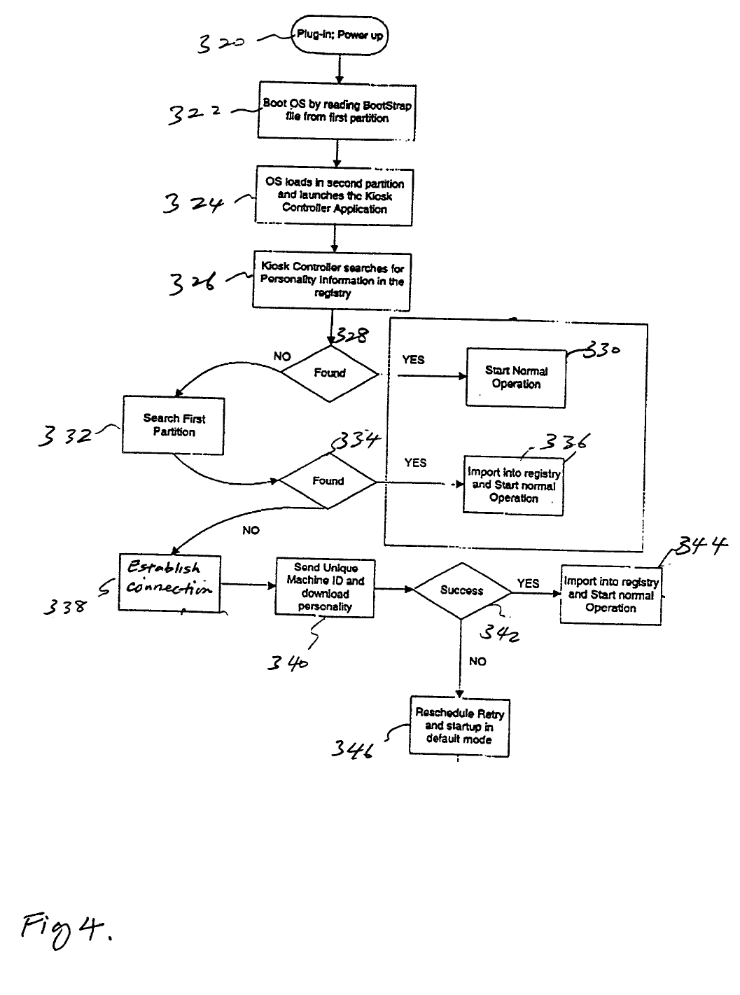

Referring to FIG. 4, a method for initiating the remote system 12 installed in the field is explained in accordance with the embodiment of the present invention. The installation of the remote system 2 is initiated as the remote system 2 is plugged into a dedicated phone line or a LAN connection and electrical power is supplied to the remote system 2 in step 320.

In step 322, the booting of the OS is initiated by reading the BootStrap file from the first partition 40. In step 324, the OS is loaded in the second partition 50 and launches the controller application 52. In step 326, the controller 52 searches for personality information in the registry of the second partition 50. If the personality information is found, a normal registration operation is executed in step 330. If not, the controller 52 searches for the personality information in the first partition 40 in step 332. If the personality is found in the first partition, the personality information is imported into the registry of the second partition 50 in step 336 and thereafter the normal registration operation is executed. If the personality information is not found in the first partition 40, the controller 52 establishes a communication connection to the NOC 20 in step 338.

In step 340, tag information or unique, machine-identifiable information (i.e., serial number of the CPU 30 of the remote system 2) is forwarded to the NOC 20, and in return the corresponding personality information is retrieved and downloaded from the database of the NOC 20. Preferably, the tag information, which is unique to each appliance, is assigned at the manufacturing stage and stored into the Basic Input Output System (BIOS) instructions that are typically stored in a refreshable, non-volatile memory such as CMOS.

In the conventional art, the installation of a remote device in the field and its connection to the NOC 20 requires the technician to enter cumbersome, detailed information which describes the remote device and its location, as well as the connectivity (or “PERSONALITY”) data into the remote device. However, entering personality data is highly proned to error and often results in connectivity failure, which in turn requires costly field service calls. Unlike the prior art, the present invention establishes a basic connectivity to the NOC 20 by simply entering tag information or a uniquely identifiable remote system number, such as the serial number of the microprocessor provided in the remote system 12. In the database of the NOC 20, each tag information is indexed with the corresponding personality information. Thus, the remote system 2 can download all necessary personality information for activation using the unique tag information that identifies that particular remote system 2.

Once the tag information is transmitted to the NOC 20, the NOC 20 searches its database and retrieves the corresponding personality information. The database in the NOC 20 can also contain the maintenance history. Here, the personality information includes location of specific advertisement information for prospective customers. In particular, whenever a company improves, changes, or modifies existing advertisement data which publishes a product and/or service and other related information, the updated advertisement data is stored as part of the personality information then broadcasted via the remote system 2. Also, the personality information includes other connectivity related information, which enable the devices to communicate with and be monitored by the NOC 20.

The retrieved personality information is transmitted back to the remote system 2 and stored in the non-volatile personality storage 43 of the first partition 40. The remote system 2 then acknowledges the receipt of the personality information and sends an acknowledgment message with the date and timestamp that the personality information was stored into the storage 43 of the remote system 2.

If downloading the personality information is successful, in step 342, this downloaded information is imported by the registry of the second partition 50 to start the initiation process. If the downloading procedure is not successful, another attempt is scheduled.

### UNATTENDED REMOTE RECOVERY PROCESS

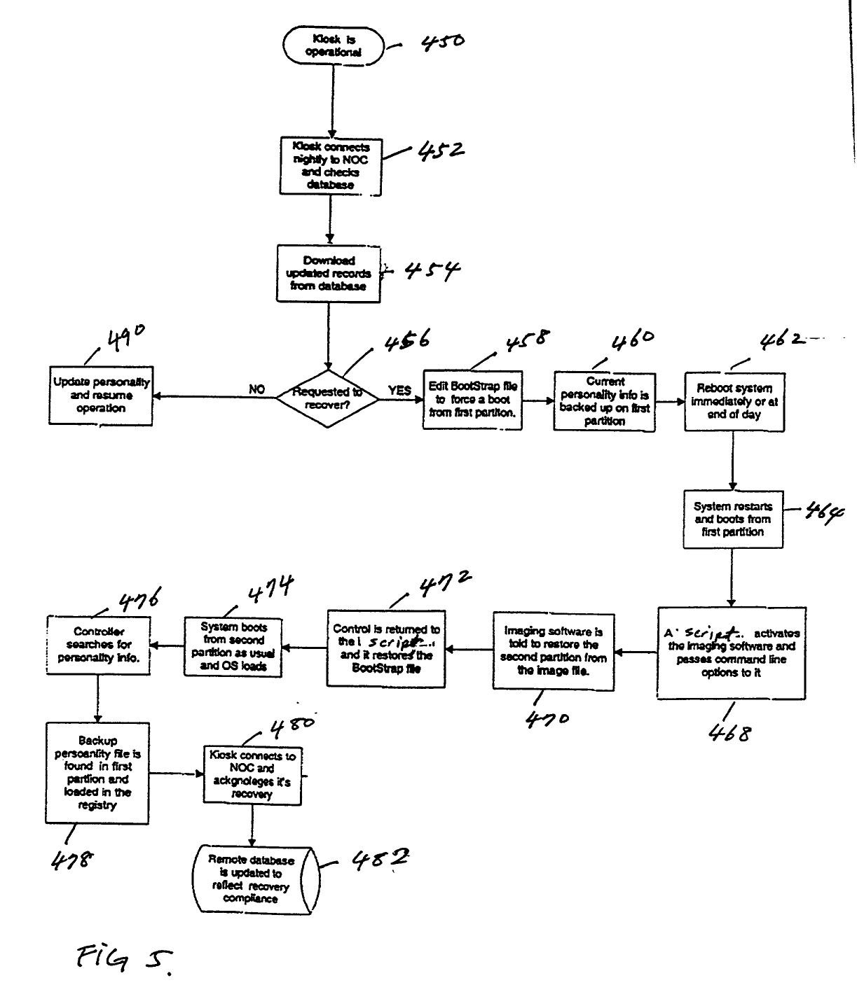

According to the present invention, once the remote system 2 is installed and initiated using the above method, the remote system 2 can be updated and recovered automatically thereafter from a remotely located NOC 20 without the intervention by any technician. Referring to FIG. 5, the remote system 2 establishes a connection to the NOC 10 during a prescribed time interval in step 452. An operator of the NOC 10 can assign the recovery mode at a prescribed time so as to trigger the remote system 2 to execute the recovery process when the remote system 2 connects to the NOC 10.

If the connection is successful, the remote system 12 and the NOC 20 exchange information in step 454. During this exchange, advertisers can obtain information on previously searched/purchased products or services and other pertinent information through the remote system 2. If a request for the recovery process is not detected in step 456, the remote system 2 updates the personality information during data exchange with the NOC 20 in step 490.

If a request to execute the recovery process is detected in step 456, the controller 52 in the second partition 50 edits the BootStrap file 41 to force a boot process to start from the first partition in step 458, thus reversing the startup order of the OS. Instead of the normal NT startup, the “Recovery” boot option 2 is activated from the first partition 40. In step 460, current personality information downloaded from the NOC 20 is backed-up in the first partition 40. The remote system 2 is then rebooted immediately (or during a designated time) in step 462.

Subsequently, an OS shutdown command will be given, then the reboot will occur and the remote system will start-up in a customized DOS environment via the first partition 40 in step 464. In step 468, a predefined script activates the image software 44, residing in the first partition 40, and passes a command line to activate the image process. In step 470, the image software 44 in the first partition 40 is activated to restored the OS of the second partition 50 automatically by copying the previously compressed data stored in the image file 42. Upon completion of the restoration, the script 45 will edit the BOOTSTRAP file 41 by changing the subsequent boot order so as to start from the second partition 50 in step 472.

Thereafter, in step 474, the remote system 2 boots from the second partition 52. In step 476, the controller 52 searches for the personality information in the first partition 40. In step 478, the previously back-up personality information in step 460 is copied to the registry of the second partition 52. Then, the remote system 2 is rebooted from the second partition 52, thereby completing the recovery process. Upon restart, the database will be updated, and the remote system 2 notifies the NOC 20 of the completion of the recovery process, in step 480. Finally, the database of the NOC 20 is updated to reflect the recovery result in step 482. It should be noted that no human intervention is needed at the location of the remote system 2 for any stage of the recovery described above.

### MANUAL RECOVERY PROCESS

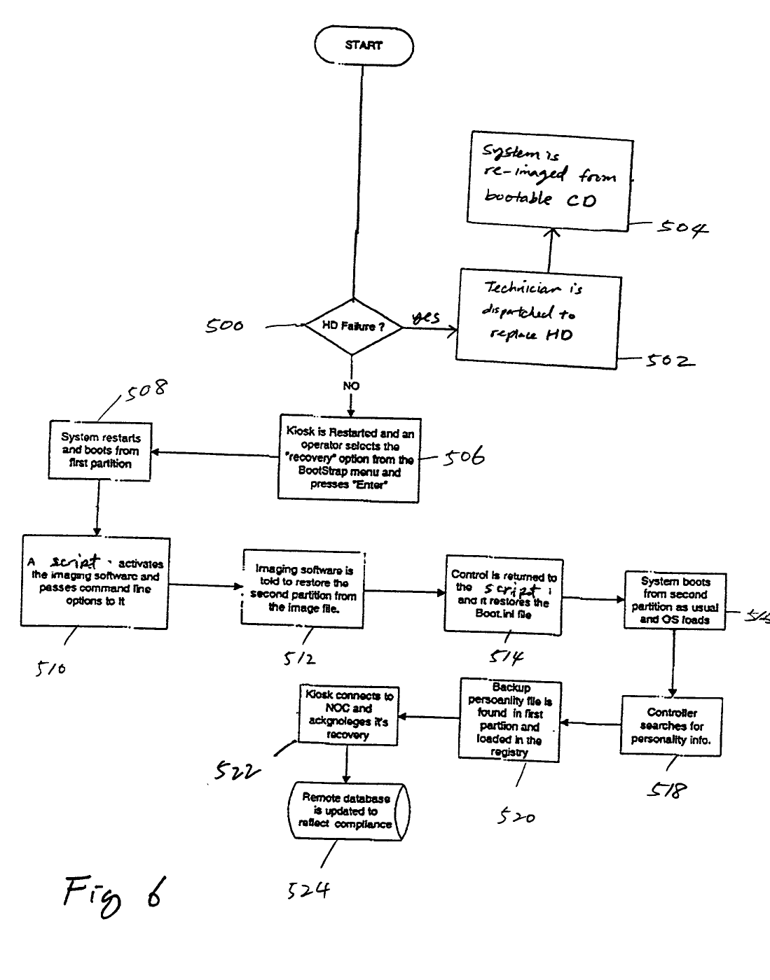

The operation of the manual recovery process is illustrated generally in FIG. 6 of the drawings. Actions are initiated when the operator is dispatched to the remote system site if an OS software or hard drive failure is detected. If hard drive failure is detected, a technician is dispatched to the site to replace the hard drive in step 502, and then the replaced hard drive is re-imaged from a bootable CD containing the OS information in step 504. If OS failure is detected, the remote system 2 is restarted by the technician in order to revive the system. To this end, the technician manually selects the recovery option 2 from the Bootstrap Menu, as shown in FIG. 2, in step 506. Then, the system restarts and boots from the first partition 40 to activate the recovery process in step 508. In step 510, the script 45 activates the image software 44 to copy the compressed data stored in the image file 42 onto the second partition 50 in step 512. In step 514, the script 45 restores the bootstrap file so as to boot the system from the second partition 50. Thereafter, the controller 52 searches for the personality information in step 518. When the backup personality information is detected in the personality storage 43 of the first partition 520, the information is loaded in the registry of the second partition in step 520. In step 522, the remote system 2 connects to the NOC 20 and reports the completion of the recovery process in order to update the database of the NOC 20 in step 524.

Having thus described a preferred embodiment for providing a completely unattended operation requiring no user intervention, it should be apparent to those skilled in the art that certain advantages of the system have been achieved. The foregoing is to be constructed as only being an illustrative embodiment of this invention. Persons skilled in the art can easily conceive of alternative arrangements providing a functionality similar to this embodiment without any deviation from the fundamental principles or the scope of this invention.

What is claimed is:

1. A method of initializing a remote system via a network operating center (NOC), comprising the steps of:
installing said remote system in a particular location;
establishing a communication channel between said remote system and said NOC having a table of personality information for a plurality of remote systems;
inputting an identifiable tag data into said remote system; and,
downloading the corresponding personality information matching said inputted tag data from said NOC.

2. The method of claim 1, wherein said personality information includes location specific advertisement and connectivity information.

3. The method of claim 1, wherein said communication channel is established via a predetermined phone number.

4. The method of claim 1, further comprising the step of notifying said NOC of the completion of said downloading step by said remote system.

5. A method for providing the unattended remote recovery of a remote system having a first partition and a second partition coupled to a network operating center (NOC), the method comprising the steps of:
imaging an operating system (OS) in said second partition;
storing a compressed image of said second partition in a given location in said first partition;
installing said remote system in a particular location;
in response to a determination that said remote system requires said recovery process at a predetermined time period, establishing a communication channel between said remote system to exchange data relating to operating said remote system;
rebooting said installed remote system via said first partition;
transferring said compressed image stored in said first partition onto said second partition; and,
rebooting said installed remote system via said second partition.

6. The method of claim 5, wherein said exchanged data includes personality information having specific advertisement and connectivity information, said personality information is downloaded into said first partition.

7. The method of claim 6, further comprising the step of transferring said personality information from said first partition onto said second partition.

8. The method of claim 5, further comprising the step of notifying said NOC of the completion of said rebooting via said second partition.

9. The method of claim 5, wherein establishing said communication step and is performed in absence of user intervention.

10. The method of claim 5, wherein said installation step includes the steps of:
inputting an identifiable tag data into said remote system, and
downloading corresponding personality information responsive to said inputted tag from the database of said NOC, said personality information including location specific advertisement and connectivity information.

11. The method of claim 5, wherein both said rebooting steps are executed manually by an operator in response to a determination that said remote system is operating improperly.

12. A system for providing unattended remote recovery of a remote system in communication with a network operating center (NOC), comprising:
a first means for storing a personality information transmitted from said NOC;
a second means for storing an operating information;
an image means disposed in said first means for storing a compressed file of said operating information of said second means;
means, responsive to the determination that said remote system is operating improperly, for selectively rebooting said remote system from one of said first means and said second means; and,
means for transferring the compressed file stored in said image means to said second storage means.

13. The system of claim 12, said personality information representative of location specific advertisement and connectivity information.

14. The system of claim 12, wherein said communication between said remote system and said NOC is established via a predetermined phone number.

15. The system of claim 12, further comprising means for storing said personality information in said first storage means.
